(19) United States
(12) Patent Application Publication
(10) Pub. No.: US 2008/0089494 A1
(43) Pub. Date: Apr. 17, 2008

(54) System and Method for Securing a Telephone System Comprising Circuit Switched and IP Data Networks

(76) Inventors: Gerard Edmond Kaas, (US); Benjamin Calais, Dallas, TX (US)

Correspondence Address: L. HOWARD CHEN;KIRKPATRICK & LOCKHART PRESTON GATES ELLIS, LLP, 55 SECOND STREET, # 1700, SAN FRANCISCO, CA, 94105, US

(21) Appl. No.: 11/937,336

(22) Filed: Nov. 8, 2007

(30) Foreign Application Priority Data
Jun. 23, 2005 (FR) 05/06401

(51) Int. Cl. H04M 1/66

(52) U.S. Cl. 379/93.02

(57) ABSTRACT

The present invention discloses a system and method for securing a telephone system comprising a circuit switched network and an IP data network. The system comprises a first firewall, between an internal IP data network and an external IP data network, for protecting the internal IP data network against intrusion; a second firewall, between the internal IP data network and a circuit switched network, for preventing intrusion originated in the external IP data network into the circuit switched network; a third firewall for protecting voice-over-IP phones against intrusion from the external IP data network; intrusion detection system (IDS) probes and time-division multiplexing (TDM) voice probes for extracting information about voice-over-IP calls over the internal IP data network; a Session Initiation Protocol (SIP) proxy server for managing voice-over-IP call control signals; and a security supervisor for managing the operation of the firewalls and the IDS and TDM voice probes.

### CROSS REFERENCE

The present application claims the benefit of French Application FR-05/06401 which was filed Jun. 23, 2005. The content of the French application is herein incorporated by reference in its entirety and a copy of the English translation of the French application is filed herewith.

### BACKGROUND

The public switched telephone network (PSTN), a circuit switched network, provides voice communication services for telephone systems. It establishes a circuit between at least two parties for exchanging voice communication. More recently, the IP data network has become the preferred medium for providing voice communication service. It exchanges data containing digitized voice between at least two parties. The convergence of the technologies for circuit switched networks and IP data networks results in high-quality voice communication services. However, the advancement in voice communication services also brings new challenges such as maintaining the reliability of the networks and defending against network attacks.

A service provider or a business entity must address these challenges at the time of installing a telephone system comprising both circuit switched and IP data networks. For example, it is essential that the IP data network achieve the same level of reliability as the circuit switched network while supporting a higher volume of voice calls. In addition, various measures need to be taken to protect against network attacks. For example, in a man-in-the-middle attack, an attacker can read, insert, and modify messages between two parties without either party knowing that the link between them has been compromised. In a denial-of-service (DoS) attack, the attacker attempts to make a computer resource unavailable to its intended users.

There are a number of ways to protect an IP data network in a business telephone system. One way is to incorporate a security management module into the business telephone system. The security management module authenticates call control requests and sends caller information to a signaling protocol management module, which authenticates the identity of the caller. However, this method only protects the business telephone system at the protocol level and it has no control over the infrastructure of the business telephone system, the client communication devices, or the server stations.

Another way is to secure voice calls exchanged between the caller and the callee. Specifically, digitized voice data is encrypted after the caller and the callee exchange digital certificates and security keys. This method protects the integrity and the security of the voice data. Yet another way involves protecting all communications exchanged between different parties by using the encryption keys.

Embodiments of the present invention provide a system and method for securing call control signaling processes, the exchange of voice data, and business telephone networks.

### SUMMARY

The present invention discloses a system and method for securing a telephone system comprising a circuit switched network and an IP data network. The system comprises a first firewall, between an internal IP data network and an external IP data network, for protecting the internal IP data network against intrusion; a second firewall, between the internal IP data network and a circuit switched network, for preventing intrusion originated in the external IP data network into the circuit switched network; a third firewall for protecting voice-over-IP phones against intrusion from the external IP data network; intrusion detection system (IDS) probes and time-division multiplexing (TDM) voice probes for extracting information about voice-over-IP calls over the internal IP data network; a Session Initiation Protocol (SIP) proxy server for managing voice-over-IP call control signals; and a security supervisor for managing the operation of the firewalls and the IDS and TDM voice probes.

The construction and method of operation of the invention, however, together with additional objects and advantages thereof, will be best understood from the following description of specific embodiments when read in connection with the accompanying drawings.

### BRIEF DESCRIPTION OF THE DRAWING

The drawings accompanying and forming part of this specification are included to depict certain aspects of the invention. The invention may be better understood by reference to one or more of these drawings in combination with the description presented herein. It should be noted that the features illustrated in the drawings are not necessarily drawn to scale.

FIG. 1 is block diagram describing a security system integrated with a business telephone system in accordance with one embodiment of the present invention.

FIG. 2 is a flow diagram illustrating a method for securing a voice communication in a business telephone system in accordance with one embodiment of the present invention.

### DESCRIPTION

The following detailed description of the invention refers to the accompanying drawings. The description includes exemplary embodiments, not excluding other embodiments, and changes may be made to the embodiments described without departing from the spirit and scope of the invention. The following detailed description does not limit the invention. Instead, the scope of the invention is defined by the appended claims.

The present invention discloses a system and method for securing a business telephone system comprising a circuit switched network and an IP data network connected to an external telephone network. The business telephone system is secured by using a plurality of firewalls to form a demilitarized zone between the circuit switched network, the internal IP data network and the external IP data network. A security supervisor manages the security of the demilitarized zone. More specifically, it monitors voice data exchanged between networks and takes appropriated actions to protect the business telephone system in accordance with the security rules.

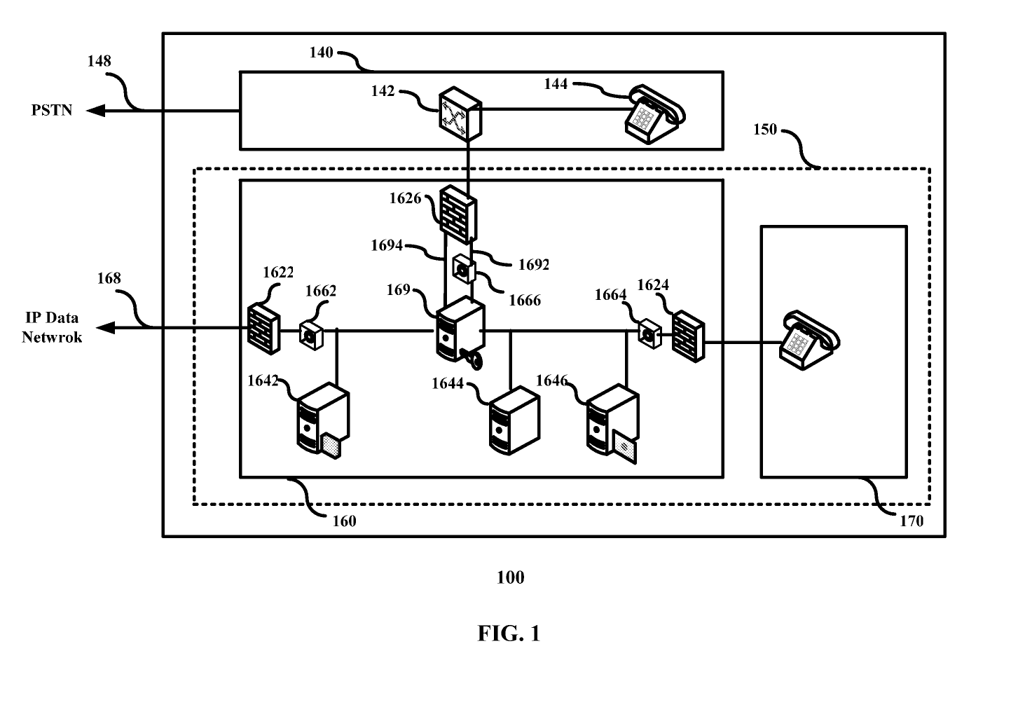

FIG. 1 is block diagram describing a security system integrated with a business telephone system in accordance with one embodiment of the present invention. The security system forms a demilitarized zone in the business telephone system.

A business telephone system 100 comprises an internal circuit switched network 140 and an internal IP data network 150. The circuit switched network 140 is connected to a public switched telephone network (PSTN) network via a connection 148 whereas the IP data network 150 is connected to an external IP Data network via a connection 168.

The circuit switched network 140 comprises a media gateway 142 and a plurality of traditional telephones 144. The media gateway 142 is the passage for telephone calls originated from or destined to traditional telephones 144 via an IP data network. More specifically, the media gateway 142 converts Integrated Services Digital Network (ISDN) call control signals into call control signal packets, which are in RTP format, and vice versa.

The IP data network 150 comprises a demilitarized zone (DMZ) 160 and a plurality of Session Initialization Protocol (SIP) phones 170. The DMZ 160 is connected to an external IP data network via the connection 168, to the internal circuit switched network 140 via the media gateway 142, and to a plurality of SIP phones 170.

The DMZ 160 comprises a plurality of firewalls 1622-1626, servers 1642-1646, and intrusion detection system (IDS) probes 1662-1664, a time-division multiplexing (TDM) voice probe 1666, and a security supervisor 169. The firewall 1622 is situated between the DMZ 160 and the external IP data network while the firewall 1624 is situated between the DMZ 160 and the plurality of SIP phones 170. Between the DMZ 160 and the circuit switched network 140 is the firewall 1626. These firewalls manage the communication ports to control the exchange of voice data between the external IP data network and the business telephone system.

Servers in the DMZ 160 include a SIP proxy server 1642, a registration server 1644, and an authentication server 1646. The SIP proxy server 1642, an essential element in the business telephone system, handles call control signals for the plurality of SIP phones 170. Once a call control signaling is completed, a voice connection is established between the SIP phones of the caller and the callee. The registration server 1644 records the association between the user/phone number and the address of a SIP phone while the authentication server 1646 authenticates the caller's identity. Moreover, the registration server 1644 and the authentication server 1646 can be integrated with the SIP proxy server 1642.

The SIP proxy server 1642 includes a detective module, which can be a software or hardware module. The detective module extracts caller and callee information from call control signal packets and sends it to the security supervisor 169. In addition, the detective module is pre-configured with a set of static rules for detecting malicious attacks. Once an attack is detected, the security supervisor 169 enters the “secured” mode.

Both IDS probes 1662-1664 and the TDM voice probe extract information from SIP call control signals. IDS probes 1662-1664 monitor the size and order of the arrival of data packets whereas the TDM voice probe 1666 is responsible for the security of the circuit switched network. Specifically, the TDM voice probe 1666 manages the connection 1692 between the security supervisor 169 and the media gateway 142, using the information extracted from SIP call control signals. Moreover, it synchronizes with the security supervisor 169 to determine whether to deny a call control request message from the caller by blocking the call from either firewalls 1622-1626 or the media gateway 142.

The security supervisor 169 comprises an audit supervisor, an expert system, a database, and at least one security module. The audit supervisor analyzes the capabilities of the SIP proxy server 1642 and the plurality of SIP phones 170. It also constructs call control signaling scenarios from which an expert system generates security rules. Subsequently, these security rules are stored in the database.

The security supervisor 169 receives caller and callee information extracted from voice data that passes through the DMZ. The caller and callee information can be extracted by IDS probes 1662-1664, the voice firewall 1666, the SIP proxy server 1642, or the media gateway 142. The security module in the security supervisor 169 checks caller and callee information against the security rules to determine whether the call is allowed.

In addition, the security supervisor 169 manages the plurality of firewalls 1622-1626. It monitors the progress of a voice communication and decides whether to open or close communication ports on the firewalls according to the security rules. The security supervisor 169 informs the SIP proxy server 1642 of the status of a call. Subsequently, the SIP proxy server 1642 updates the database and records the status of the call. If the call is between the circuit switched network 140 and the IP data network 150, the SIP proxy server 1642 informs the media gateway 142 of the status of the call.

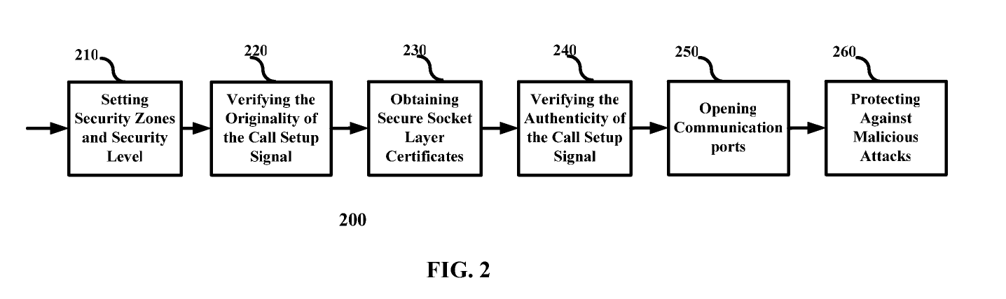

FIG. 2 is a flow diagram illustrating a method for securing a voice communication in a business telephone system in accordance with one embodiment of the present invention. A business telephone system is divided into security zones: normal, critical, and highly critical. Moreover, a communication device (e.g. a Session Initialization Protocol phone) in a security zone is assigned a security level: weak, normal, and maximum (step 210). According to the location and the importance of the user of a communication device, the security policy of a business telephone system determines which security zone and which security level will be assigned to the communication device

The security policy also defines a set of actions that would be applied to call control request messages. The set of actions correspond to the security zone and security level of a caller, and the SIP proxy server routes the call accordingly. If a call should not reach a callee, one of the following actions is taken: the call is re-routed to the operator in the security zone; the call is forwarded to the callee's voicemail; the call is re-directed to a specific recipient such as a secretary; or the call is disconnected with a recorded message explaining the reason why the call cannot go through.

In step 220, the security supervisor opens the firewall if it verifies that the caller and the SIP proxy server initiating the call control message are originated from the same trusted domain. The following are two messages in the standard format of a SIP call control message.

Message 1:

INVITE sip:callee@domain.com SIP/2.0

Contact: sip:caller@u1.example.com

Record-Route: <sip:p1.example.com;lr>

Message 2:

INVITE sip:callee@domain.com SIP/2.0

Contact: sip:caller@u1.example.com

Record-Route: <sip:p1.pirate.com;lr>

Message 1 shows that the caller is from example.com. The Record-Route field shows that the call is routed through a proxy server, p1.example.com. Apparently, both the caller and the proxy server reside in the same domain (example.com).

On the contrary, message 2 shows that the caller is from example.com. However, the call is routed through a pirate.com domain. Since the caller and the proxy server are not originated from the same domain, it makes sense to speculate that the call control message may not be genuine. Consequently, the security supervisor will block the call and instruct the firewall to close the communication port associated with this call.

In step 230, upon receiving an INVITE message, the SIP proxy server of the callee acquires a Secure Sockets Layer (SSL) certificate from that of the caller, and vice versa. The SIP proxy server of the callee and that of the caller use the SSL certificates to establish a secured channel.

In step 240, the security supervisor of the callee verifies whether the incoming call control request message is actually originated from the SIP proxy server of the caller and whether the packets traverse a coherent path. The verification process starts when an INVITE call control message is received. The SIP proxy server of the callee issues a dynamic name service (DNS) query to resolve the IP address of the SIP proxy server of the caller. Next, it uses a proprietary dialogue to retrieve the caller-ID from the SIP proxy server of the caller via a secured channel, established by using the SSL certificates obtained in step 230. The messages exchanged between the SIP proxy servers of the caller and the callee are encrypted using the session keys generated from the SSL certificates.

Next, the security proxy server of the callee sends the SIP proxy server of the caller a query containing messages such as “the path for sending the query message” and “the identifier of the caller.” In response to the query, the SIP proxy server of the caller returns a query containing messages such as “presence or absence of one or more calls for the indicated person” and “list of CALL-ID of the communications in progress.”

Once the authenticity of the call is verified, the security supervisor dynamically opens the communication port on the firewall for the voice-over-IP call (step 250). To carry voice data in the RTP media flow, the networking protocol selects communication ports dynamically. For security reasons, the selected communication ports should not be numbered sequentially. The information about the selected communication ports is embedded in call control signals carrying information about the caller and the SIP proxy server of the caller. After obtaining port information, the security supervisor configures the firewall to open or close the communication ports accordingly

In step 260, the method disclosed in the present invention secures the business telephone network by providing protection against malicious attacks. In one embodiment of the present invention, the business telephone network is protected against an attacker's spoofing SIP messages. The attacker can redirect, disconnect, or modify an on-going voice call. During the acceptance of an “INVITE” message from a caller, a message “3xx,” which indicates that the call can be joined from another area, can be piggybacked to the “INVITE” message. An attacker can intercept the original “INVITE” message, add a “3xx” to the original message, and re-direct the call to another communication device. The security supervisor must verify whether the caller is authorized to re-direct the call to another communication device or another area according to the security policy of the business telephone system.

An attacker can also send a “BYE” call control message to force the SIP proxy server to terminate an on-going call. To protect a business telephone system from this type of attack, the SIP proxy server must be configured in such a way that it needs verification that the incoming message is originated from the caller of a confirmed security level before it terminates the call. More specifically, when a SIP proxy server receives a “BYE” message, it first checks whether the message traverses a coherent path. If the message is deemed to traverse a coherent path, the SIP proxy server sends a query to a DNS to resolve the IP address of the caller's proxy server to confirm the authenticity of the communication device originating the message.

In another type of attack, an attacker can first send a “BYE” call control message and then a “REINVITE” call control message to force the SIP proxy server to modify the properties of an on-going call. For example, the attacker can change an on-going call from a voice call to a multimedia call or something else. To defend against this type of attack, the SIP proxy server receiving a “REINVITE” message must verify the authenticity of the communication device that issues the message, using the same procedure described above, before taking any action. Once the authenticity is determined, the SIP proxy server confirms whether the modification of the properties of the on-going call is authorized according to the security policy.

In another embodiment, the business telephone system is protected against an attacker's overloading the IP data network by piggybacking extra data in an on-going voice call. The voice data between the caller and callee are exchanged via one or more Real Time Protocol (RTP) tunnels. The RTP tunnels are established and torn down dynamically and they do not pass through the SIP proxy server. An attacker can create an RTP flood by inserting additional data flows into an RTP tunnel. These additional data flows overflow the RTP tunnel and hence disrupt the service provided by the IP data network.

One or more IDS probes are placed in the data path of an RTP data flow to monitor the size and order of the arrival of data packets in an RTP tunnel. The security supervisor analyzes the temporal property of an RTP data flow and compares it with the pattern associated with the voice codec (coding algorithm) used by the voice call. An RTP flood is detected if the temporal property and voice call pattern do not agree. Consequently, the security supervisor can close the RTP tunnel carrying the RTP data traffic.

In still another embodiment, the business telephone system is protected against stalking by a caller. The security supervisor collects a set of the statistics about an individual caller. The statistics include the number of calls within a predetermined period, the average time interval between two consecutive calls, and the identity of the caller. Once a caller is identified as a stalker, the security supervisor decides to block the call from this particular caller, re-direct it to an operator, or forward it to a voice mailbox, according to the security policy.

In yet another embodiment, the business telephone system is protected against denial-of-service (DOS) attacks on a SIP proxy server or a registration server. An attacker can overwhelm the SIP proxy server by issuing a large quantity of SIP call control messages or issuing a call control message to a non-existing callee. It can also overwhelm the registration server by issuing numerous registration requests; consequently, the registration server is unable to process a registration request from a genuine caller.

Routinely, the security supervisor and a plurality of IDS probes work in corporation to detect DoS attacks. The IDS probes monitor on-going calls that enter the business telephone system from an external IP data network. The security supervisor analyzes the volume and pattern of SIP call control messages from each caller in order to detect abnormal call control signaling activities. To defend the business telephone system against a DoS attack, the SIP proxy server needs to be configured in such a way that it will limit the number of SIP call control messages and registration requests that can be issued by a caller within a predetermined period of time.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A system for securing a telephone system comprising at least one circuit switched network and at least one IP data network, the system comprising:
a first firewall, situated between an internal IP data network and an external IP data network, for protecting the internal IP data network against intrusion;
a second firewall, situated between the internal IP data network and a circuit switched network, for preventing intrusion that is originated in the external IP data network into the circuit switched network;
a third firewall for protecting a plurality of voice-over-IP phones against intrusion from the external IP data network;
at least one intrusion detection system (IDS) probe and at least one time-division multiplexing (TDM) voice probe for extracting information about voice-over-IP calls over the internal IP data network;
a Session Initiation Protocol (SIP) proxy server for managing voice-over-IP call control signals; and
a security supervisor for managing the operation of the first, the second and the third firewalls and the at least one IDS probe and the at least one TDM voice probe.

2. The system of claim 1, wherein the first firewall manages one or more communication ports to control exchange of voice data between the internal IP data network and the external IP data network.

3. The system of claim 1, wherein the second firewall manages communication ports to control exchange of voice data between the internal IP data network and the circuit switched network.

4. The system of claim 1, wherein the third firewall manages communication ports to control voice data to and from the plurality of voice-over-IP phones.

5. The system of claim 1, wherein the at least one IDS probe extracts information from SIP call control signals.

6. The system of claim 1, wherein the at least one TDM voice probe synchronizes with the security supervisor to determine whether to deny a call control request from a caller by blocking it from a firewall.

7. The system of claim 1, wherein the SIP proxy server comprises a registration server and an authentication server.

8. The system of claim 7, wherein the SIP proxy server further comprises a detective module.

9. The system of claim 8, wherein the detective module extracts caller and callee information from the call control signals.

10. The system of claim 8, wherein the detective module is pre-configured with a set of static rules for detecting predetermined malicious attacks.

11. The system of claim 7, wherein the registration server records a predetermined association between the user/phone number and the address of a SIP phone.

12. The system of claim 7, wherein the authentication server authenticates the caller's identity.

13. The system of claim 1, wherein the security supervisor comprises an audit supervisor, an expert system, a database, and at least one security module.

14. The system of claim 13, wherein the audit supervisor analyzes the capabilities of the SIP proxy server and the plurality of SIP phones.

15. The system of claim 1, wherein the security supervisor receives caller and callee information that is extracted from voice data by the IDS probes, the TDM voice probe, and the SIP proxy server.

16. A method for securing a telephone system with at least one circuit switched network and at least one IP data network by using one or more firewalls to protect voice-over-IP calls, the method comprising:
dividing the telephone system into a plurality of security zones and assigning a security level to one or more communication devices in the plurality of security zones;
verifying that a caller initiating at least one call control signal and a SIP proxy server are originated from at least one trusted domain and that the caller is allowed to establish a voice-over-IP call with a callee in the telephone system based on a security rule;
confirming a caller's authenticity with the SIP proxy server via a secured channel that is established by using the one or more Secure Sockets Layer certificates;
opening at least one communication port on the one or more firewalls for the voice-over-IP call; and
monitoring the at least one call control signal and the voice-over-IP call to gather information about the voice-over-IP call.

17. The method of claim 16, wherein the dividing the telephone system into the plurality of security zones depends on a location and importance of the user of the communication device.

18. The method of claim 16, wherein the confirming the caller's authenticity is carried out using a proprietary dialog between the SIP proxy servers of the caller and callee.

19. The method of claim 16, wherein the communication ports must not be numbered sequentially.

20. The method of claim 16, wherein the monitoring the at least one call control signal and the voice-over-IP call further comprises:
examining the at least one call control signal to detect spoofing of the information;
monitoring the content of voice data to detect overloading of the at least one IP data network by attackers;
preventing a communication device from being stalked by attackers; and
protecting a plurality of servers in a telephone system against denial-of-service attacks.

21. The method of claim 20, wherein the examining the at least one call control signal further comprises:
verifying that a caller is authorized to re-direct a call to another communication device or another area;
verifying that an incoming call is originated from the caller in a confirmed security zone;
verifying that the at least one call control signal traverses a coherent path; and
verifying that a modification of the properties of an on-going voice-over-IP call is authorized.

22. The method of claim 20, wherein the monitoring the content of voice data includes analyzing and comparing a temporal property of a voice data flow with a pattern associated with the voice codec.

23. The method of claim 20, wherein the preventing the communication device from being stalked by attackers depends on collecting statistics including the number of calls within a predetermined period, the average time interval between two consecutive calls, and the identity of the caller.

24. The method of claim 20, wherein the protecting the plurality of servers in the telephone system against denial-of-service attacks further comprises:
monitoring volume and pattern of on-going calls that enter the telephone system; and
limiting the number of requests that enter the telephone system within a predetermined period of time system and method for securing a telephone system comprising circuit switched and IP data networks.
